(19) United States
(12) Patent Application Publication
(10) Pub. No.: US 2003/0031408 A1
(43) Pub. Date: Feb. 13, 2003

(54) Mode sensitive filter and optical transmitter/receiver

(76) Inventor: Takeshi Ota, Tokyo (JP)

Correspondence Address: NOTARO AND MICHALOS, 100 DUTCH HILL ROAD, SUITE 110, ORANGEBURG, NY, 10962-2100, US

(21) Appl. No.: 10/177,344

(22) Filed: Jun. 24, 2002

(30) Foreign Application Priority Data
Jul. 6, 2001 (JP) 2001-205750

(51) Int. Cl. G02B 6/26

(52) U.S. Cl. 385/28; 385/39; 385/27

(57) ABSTRACT

An optical transmitter/receiver provided with a mode sensitive filter configured by joining an optical fiber or optical waveguide having a single transmission mode at a long wavelength (1.2-1.7 μm) and an optical fiber or optical waveguide having a single transmission mode at a short wavelength (0.6-1.0 μm). With this construction, the optical transmitter/receiver can remove high-order modes generated when transmitting light having a short wavelength along optical fibers having a single transmission mode in the long wavelength range. Accordingly, it is possible to perform broadband transmissions using an inexpensive, short wavelength optical transmitter/receiver.

### FIELD OF THE INVENTION

The present invention relates to an optical transmitter and receiver and a mode sensitive filter therefor.

### BACKGROUND OF THE INVENTION

Optical fibers known as single-mode fibers are widely used in the art. In its broad sense, a single-mode fiber is the generic term for an optical fiber that supports only one transmission mode at any one time. More specifically, a single-mode fiber is an optical fiber supporting a single transmission mode at a wavelength of 1.2 μm or greater. A single-mode fiber of the latter definition normally has a core diameter of about 10 μm.

It is well known in the art that a plurality of transmission modes will be generated when attempting to transmit light with a wavelength of 0.78 μm, for example, along this type of single-mode fiber. FIG. 4 is an explanatory diagram showing this process. In a fiber with a core diameter Da of 10 μm, light having a wavelength λa of 1.3 μm propagates in a single mode, as shown in FIG. 4(a). However, when transmitting light with a wavelength λb of 0.78 μm, a plurality of transmission modes is generated, as shown in FIG. 4(b). A single transmission mode can also be achieved for the wavelength λb by using an optical fiber having a core diameter Db of 6 μm.

Multiple transmission modes give rise to problems of differential mode delay (DMD) caused by each transmission mode traveling in a different optical path. DMD is known to greatly degrade the data transfer rate. Accordingly, high-speed optical communications are not possible when multiple transmission modes are generated in the fiber.

On the other hand, semiconductor lasers used as light emitting elements for optical transmitters/receivers that emit a wavelength of 1.3 μm (or 1.5 μm) are more expensive than lasers having a wavelength of 0.78 μm (or 0.85 μm) because the semiconductor lasers with longer wavelengths (1.2-1.70 μm) are fabricated on indium phosphide (InP) substrates, while short wavelength (0.6-0.9 μm) semiconductor lasers are formed on gallium arsenide (GaAS) substrates. Short wavelength semiconductor lasers are mass-produced for use in optical discs, such as compact discs and DVDs, thereby reducing the costs of related materials and manufacturing equipment. On the other hand, InP semiconductor lasers are limited in applications to optical communications and, therefore, require more expensive materials and manufacturing equipment.

Further, it has been cheaper to manufacture light-receiving devices for short wavelengths (0.6-0.9 μm) because photodiodes on silicon (Si) or GaAs substrates can be used. Photodiodes supporting longer wavelengths (1.2-1.70 μm) have been more expensive to manufacture because they require the use of InP material.

Today there is a great demand for low-cost optical transmitters/receivers for access networks. Short wavelength optical transmitters and receivers are more advantageous in reducing costs, for the same reasons as described above. However, a large amount of single-mode fibers (optical fibers having a single transmission mode in the above long wavelength region) are already in existence, presenting difficulties in laying new optical fibers having different core diameters.

### DISCLOSURE OF THE INVENTION

In view of the foregoing, it is an object of the present invention to provide a short wavelength optical transmitter/receiver capable of being used with optical fibers having a single transmission made in a long wavelength range.

This object and others will be achieved by an optical transmitter/receiver according to the present invention comprising an optical fiber or an optical waveguide having a single transmission mode in a long wavelength range (1.2-1.7 μm) and a mode sensitive filter connected to an optical fiber or an optical waveguide having a single transmission mode in a short wavelengthBACKGROUND OF THE INVENTION range (0.6-1.0 μm). With this construction, the optical transmitter/receiver can remove high-order modes generated when transmitting light having a short wavelength along optical fibers having a single transmission mode in the long wavelength range. Accordingly, it is possible to perform broadband transmissions using a short wavelength optical transmitter/receiver comprising inexpensive light-emitting and light-receiving devices. A particular feature of the present invention is its selection of semiconductor lasers formed of inexpensive GaAs-AlGaAs with a wavelength of 0.75-0.88 μm and the most common single-mode optical fibers used in optical communications with an operating wavelength of 1.30-1.65 μm. With this construction, it is possible to anticipate the present invention being applied to a wide-range of applications at the lowest cost possible.

### BRIEF DESCRIPTION OF THE DRAWINGS

In the drawings:

FIG. 1 is a plan view showing the general construction of an optical transmitter/receiver according to the first embodiment of the present invention;

FIG. 2 is an explanatory diagram showing the general communication process between optical transmitters/receivers of the present invention;

FIG. 3 is a plan view showing the construction of an optical transmitter/receiver according to a second embodiment of the present invention; and

FIG. 4 is an explanatory diagram showing the process in which single transmission modes and multiple transmission modes are generated according to the core diameter of the fiber and the wavelength of the light.

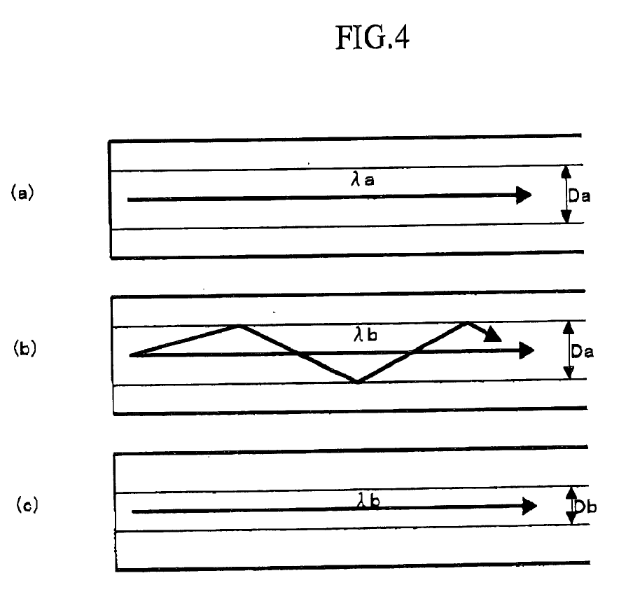

### BEST MODE FOR CARRYING OUT THE INVENTION

Preferred embodiments of the present invention will be described while referring to the accompanying drawings.

[FIRST EMBODIMENT]

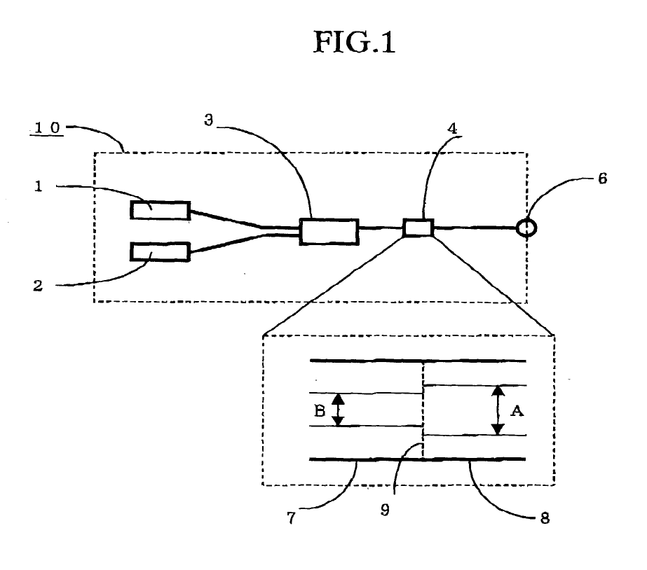

FIG. 1 shows the basis construction of a optical transmitter/receiver according to the first embodiment of the present invention. An optical transmitter/receiver 10 of the present invention comprises a semiconductor laser 1, a photodiode 2, a WDM (wavelength division multiplexing) optical fiber coupler 3, and a mode sensitive filter 4. The semiconductor laser 1 employs an AlGaAs laser grown on a GaAs substrate. The photodiode 2 is a light-receiving element that comprises a Si-Pin photodiode grown on a Si substrate. The mode sensitive filter 4 is configured such that an optical fiber 7 having a core diameters B of 6 μm and an optical fiber 8 having a core diameter A of 10 μm are coaxially fusion spliced together at an interface 9. Light having a wavelength 0.78 μm (or 0.85 μm) travels in a single mode on the optical fiber 7 end of the mode sensitive filter 4. This short wavelength from the optical fiber 7 end is coupled with the lowest order mode on the optical fiber 8 end.

While light having a wavelength or 0.78 μm (or 0.85 μm) can propagate in a plurality of transmission modes in the optical fiber 8 end of the mode sensitive filter 4, transmission modes other than the lowest order transmission mode in the optical fiber 8 end cannot exist in the core of the optical fiber 7. Light or these other transmission modes is absorbed into the cladding of the optical fiber 7 and attenuated.

According to the behavior described above, the mode sensitive filter 4 has the effect of exciting only the lowest order mode on the transmission end in an existing optical fiber having a large core diameter, eliminating all modes other than this lowest order mode. Hence, only the lowest order mode is received on the reception end. Even when only the highest order mode in an optical fiber with a wide core is excited on the transmission end, bends and the like in the optical fiber can convert the lowest order mode to a high order mode, causing the differential mode delay described above. However, the mode sensitive filter eliminates this high order mode on the reception end.

While it is conceivable to provide a mode sensitive filter only on the reception end, it is possible that a high order mode will be converted to the lowest order mode when numerous high order modes are generated during transmission. In this case, it is not possible to predict where mode conversion will occur on the transmission path. As a result, a phenomenon essentially the same as the differential mode delay occurs in the lowest order mode of received light, causing bandwidth limitations. Accordingly, it is desirable to provide a mode sensitive filter 4 on both the transmission and reception ends. The optical transmitter/receiver 10 of the first embodiment shown in FIG. 1 meets these conditions.

The semiconductor laser 1 in FIG. 1 employs a wavelength from 0.78 to 0.85 μm. Light from the semiconductor laser 1 having a wavelength 0.78 μm, for example, is transmitted via the WDM optical fiber coupler 3 and mode sensitive filter 4 and out through a transmission port 6. Similarly, an optical signal having a wavelength of 0.85 μm, for example, from an external source is transmitted to the photodiode 2 via the mode sensitive filter 4 and WDM optical fiber coupler 3.

Paired with this optical transmitter/receiver is an additional optical transmitter/receiver having a semiconductor laser 1 that generates a wavelength of 0.85 μm. Light from this semiconductor laser 1 having a wavelength 0.85 μm is transmitted via the WDM optical fiber coupler 3 and mode sensitive filter 4 and out through tho transmission port 6. On the other hand, an optical signal having a wavelength of 0.78 μm, for example, from an external source is transmitted to the photodiode 2 via the mode sensitive filter 4 and WDM optical fiber coupler 3.

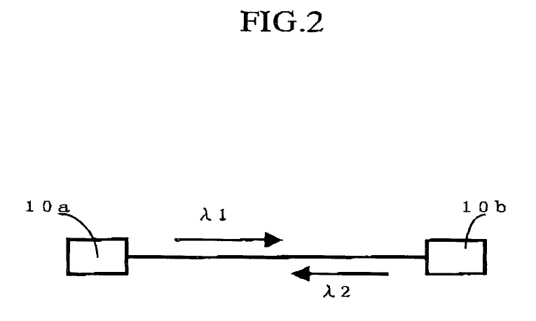

FIG. 2 shows the general communication process between optical transmitters/receivers of the present invention. A first optical transmitter/receiver 10a transmits light having a wavelength of 0.78 μm, while a second optical transmitter/receiver 10b transmits light having a wavelength of 0.85 μm. Here, bi-directional transmission is conducted in a single optical fiber by transmitting a signal in one direction at one wavelength and in the opposite direction at a different wavelength.

While the present embodiment describes an optical transmitter/receiver for performing single-fiber bi-directional transmission, it is obvious that the present invention can also be applied to an optical transmitter/receiver using separate optical fibers for the transmission line and reception line. The present embodiment also employs a method for changing the wavelength from one direction to the other. However, the present invention can also be applied to a method of performing single-fiber bi-directional transmission using the same wavelength for both directions. In this case, an ordinary optical fiber coupler can be used in place of the WDM optical fiber coupler 3 in FIG. 1.

Further, while the semiconductor laser 1 serving as the light emitting element of the present embodiment is an AlGaAs laser grown on a GaAs substrate and having a wavelength of 0.75-0.88 μm, it is also possible to use an AlGaInP laser grown on a GaAs substrate and having a wavelength of 0.63-0.68 μm or an AlGaAs-GaInAs strained quantum-well laser formed on a GaAs substrate and having a wavelength of 0.9-1.0 μm. It is also possible to employ a light-emitting diode of the same materials as described above in place of the semiconductor laser. A light-emitting element grown on a GaAs substrate can be manufactured at a lower cost than light-emitting elements grown on InP substrates. Of those devices, the AlGaAs laser (wavelength of 0.75-0.88 μm) is particularly cost effective. Accordingly, it is particularly desirable to design the characteristics of the mode sensitive filter 4 to suit this wavelength range.

Further, a Si-PIN diode is used as the photodiode 2 in the present embodiment, but a high-sensitive Si-APD (Avalanche Photodiode) can also be used. A photodiode grown on a Si substrate can be manufactured at a lower cost than a light-receiving device formed on an InP substrate. However, this photodiode has only sufficient sensitivity to detect wavelengths shorter than about 1.0 μm. A GaAs photodiode can also be used instead of the Si photodiode. A GaAs photodiode is cheaper than an InP photodiode and can perform faster operations than a Si photodiode. The GaAs photodiode has the advantage of performing operations at a speed of 2.5 Gbps or 10 Gbps, while Si photodiodes have difficulty operating at speeds or 2.5 Gbps or greater.

Since most existing single-mode fibers were designed to be used in the range of 1.3-1.65 μm, it is particularly desirable to manufacture mode sensitive filter 4 with characteristics suited to this wavelength range.

[SECOND EMBODIMENT]

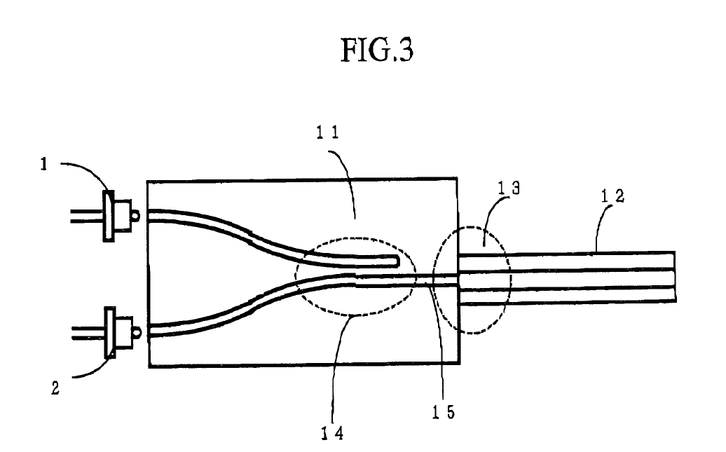

FIG. 3 is a plan view showing the construction of an optical transmitter/receiver according to a second embodiment of the present invention. The optical transmitter/receiver of the present embodiment is configured of a WDM coupler 14 disposed on a planar optical waveguide substrate 11. A mode sensitive filter 13 is formed at the junction between the planar optical waveguide substrate 11 and an optical fiber 12. The semiconductor laser 1 and photodiode 2 are the same as those in the first embodiment shown in FIG. 1.

The mode sensitive filter 13 of the present embodiment is configured such that a waveguide 15 formed on the planar optical waveguide substrate 11 has a small cross-sectional area in order to generate a single mode on the short wavelength end. Since the optical fiber 12 is a normal single-mode optical fiber (an optical fiber having a single transmission mode of a long wavelength), a plurality of transmission modes exists in the optical fiber 12 at short wavelengths. As described above, the mode sensitive filter can be constructed by joining the waveguide 15 and optical fiber 12.

In the present embodiment, a mode sensitive filter is configured by combining a single-mode planar optical waveguide on the short wavelength end and a single-mode optical fiber on the long wavelength end. Conversely, a mode sensitive filter can be constructed by combining a single-mode optical fiber on the short wavelength end and a single-mode planar optical waveguide on the long wavelength end. Further, it is possible to construct a mode sensitive filter by combining a single-mode planar optical waveguide on both the short wavelength end and the long wavelength end.

In the above description, either the core diameter of the optical fiber or the cross-sectional area of the optical waveguide is modified to vary the waveband having a single transmission mode. However, the wavelength can also be varied by changing the refractive index difference between the core and cladding.

The optical transmitter/receiver and mode sensitive filter therefor according to the present invention can achieve broadband signal transmission without the problem of differential mode delay by using a low cost short wavelength optical transmitter and existing long wavelength single-mode optical fibers.

What is claimed is:

1. A mode sensitive filter comprising a first optical fiber having a single transmission mode at a first wavelength and a second optical fiber connected to the first optical fiber that generates a plurality of transmission modes at the first wavelength and has a single transmission mode at a second wavelength longer than the first wavelength.

2. A mode sensitive filter comprising a first optical fiber having a single transmission mode at a wavelength from 0.60 μm to 1.0 μm and a second optical fiber having a single transmission mode at a wavelength from 1.20 μm to 1.70 μm.

3. A mode sensitive filter as recited in claim 2, wherein the first optical fiber particularly has a single transmission mode at a wavelength from 0.75 μm to 0.88 μm and the second optical fiber particularly has a single transmission mode at a wavelength from 1.30 μm to 1.65 μm.

4. A mode sensitive filter comprising an optical waveguide having a single transmission mode at a first wavelength and an optical fiber connected to the optical waveguide that generates a plurality of transmission modes at the first wavelength and has a single transmission mode at a second wavelength longer than the first wavelength.

5. A mode sensitive filter comprising an optical waveguide having a single transmission mode at a wavelength from 0.60 μm to 1.0 μm and an optical fiber having a single transmission mode at a wavelength from 1.20 μm to 1.70 μm.

6. A mode sensitive filter as recited in claim 5, wherein the optical waveguide particularly has a single transmission mode at a wavelength from 0.75 μm to 0.88 μm and the optical fiber particularly has a single transmission mode at a wavelength from 1.30 μm to 1.65 μm.

7. A mode sensitive filter comprising an optical fiber having a single transmission mode at a first wavelength and an optical waveguide connected to the optical fiber that generates a plurality of transmission modes at the first wavelength and has a single transmission mode at a second wavelength longer than the first wavelength.

8. A mode sensitive filter comprising an optical fiber having a single transmission mode at a wavelength from 0.60 μm to 0.90 μm and an optical waveguide having a single transmission mode at a wavelength from 1.20 μm to 1.70 μm.

9. A mode sensitive filter as recited in claim 8, wherein the optical fiber particularly has a single transmission mode at a wavelength from 0.75 μm to 0.88 μm and the optical waveguide particularly has a single transmission mode at a wavelength from 1.30 μm to 1.65 μm.

10. A mode sensitive filter comprising a first optical waveguide having a single transmission mode at a first wavelength and a second optical waveguide connected to the first optical waveguide that generates a plurality of transmission modes at the first wavelength and has a single transmission made at a second wavelength longer than the first wavelength.

11. A mode sensitive filter comprising a first optical waveguide having a single transmission mode at a wavelength from 0.60 μm to 0.90 μm and a second optical waveguide having a single transmission mode at a wavelength from 1.20 μm to 1.70 μm.

12. A mode sensitive filter as recited in claim 11, wherein the first optical waveguide particularly has a single transmission mode at a wavelength from 0.75 μm to 0.88 μm and the second optical waveguide particularly has a single transmission mode at a wavelength from 1.30 μm to 1.65 μm.

13. An optical transmitter/receiver comprising:
a light emitting element,
a light-receiving element, and
a mode sensitive filter,
the mode sensitive filter comprising a first optical fiber having a single transmission mode at first wavelength and a second optical fiber connected to the first optical fiber that generates a plurality of transmission modes at the first wavelength and has a single transmission mode at a second wavelength longer than the first wavelength.

14. An optical transmitter/receiver comprising:
a light emitting element,
a light-receiving element, and
a mode sensitive filter,
the mode sensitive filter comprising an optical waveguide having a single transmission mode at a first wavelength and an optical fiber connected to the optical waveguide that generates a plurality of transmission modes at the first wavelength and has a single transmission mode at a second wavelength longer than the first wavelength.

15. An optical transmitter/receiver comprising:
a light emitting element,
a light-receiving element, and
a mode sensitive filter,
the mode sensitive filter comprising an optical fiber having a single transmission mode at first wavelength and an optical waveguide connected to the optical fiber that generates a plurality of transmission modes at the first wavelength and has single transmission mode at a second wavelength longer than the first wavelength.

16. An optical transmitter/receiver comprising:
a light emitting element,
a light-receiving element, and
a mode sensitive filter,
the mode sensitive filter comprising a first optical waveguide having a single transmission mode at a first wavelength and a second optical waveguide connected to the first optical waveguide that generates a plurality of transmission modes at the first wavelength and has a single transmission mode at a second wavelength longer than the first wavelength.

17. At optical transmitter/receiver as recited in claim 13, wherein the light emitting element is a semiconductor device formed on a gallium arsenide (GaAs) substrate.

18. An optical transmitter/receiver as recited in claim 13, wherein the light-receiving element is a semiconductor device formed on a silicon (Si) substrate.

19. An optical transmitter/receiver as recited in claim 13, wherein the light-receiving element is a semiconductor device formed on a gallium arsenide (GaAs) substrate.
